(19) United States
(12) Patent Application Publication
(10) Pub. No.: US 2009/0019670 A1
(43) Pub. Date: Jan. 22, 2009

(54) Castor

(76) Inventor: Haiming Tsai, Tainan Hsien (TW)

Correspondence Address: Haiming TSAI, P.O. Box 6-9 717, Tainan, TW

(21) Appl. No.: 11/879,588

(22) Filed: Jul. 19, 2007

(51) Int. Cl. B60B 33/00

(52) U.S. Cl. 16/35 R

(57) ABSTRACT

This invention is a castor, including the castor main body, brake system, directional system, release mechanism and a number of positioning elements. One side of the castor main body has a brake system and a directional system, allowing the user to easily carry out braking or release the brakes simply by pressing the brake system or directional system, making the brake flexible platelet move and press against the wheel surface. Also because the fluted disc on the brake system and the brake flexible platelet is combined into one, the fluted disc will, at the same time, move up and engage with the direction change fluted disc, applying the brakes and maintaining direction. By pressing down the directional system the castor can also be set to move in a straight line only.

### BACKGROUND OF THE INVENTION

1. Field of the Invention

This invention is a castor, the brakes and direction of which can be controlled by a single application of downward pressure.

2. Description of the Prior Art

Ordinary castors have a braking mechanism to allow position to be fixed. FIG. 1 shows a commonly-seen castor brake mechanism design. It is made up of the wheel stand 10, shaft lever 11, wheel body 12, a vertical shaft lever 13 which passes through them, brake plate 14 and pressed plate 15.

To brake the commonly-seen castor described above as shown in FIG. 2, when the pressed plate 15 is pushed down, its brake plate 14 will be pressed down by the external pressure and press against the wheel body 12 and the pressed plate is set in the downward position. Shortcomings are: when the brake is released the user has to bend down and move the pressed plate up, so that brake plate 14 separates from wheel body 12. This means the castor braking mechanism is very inconvenient to use. Also, the gap between wheel frame 10 and the wheel body 12 is too wide and the castor is often stuck when it becomes entangled with hair. Although the castor does not roll when the brake is applied it can still change direction.

### SUMMARY OF THE INVENTION

The main objective of this invention is to provide a castor that allows brakes and turn direction to be simultaneously set or single wheel direction set for straight line movement.

The objective of this invention is to provide a castor, the brakes of which can be easily applied, direction set or released by a downward pressing movement.

### BRIEF DESCRIPTION OF DRAWINGS

This invention will be better understood by referring to the accompanying drawings, wherein:

FIG. 1 is a cross-sectional view of a known conventional castor being operated in a way

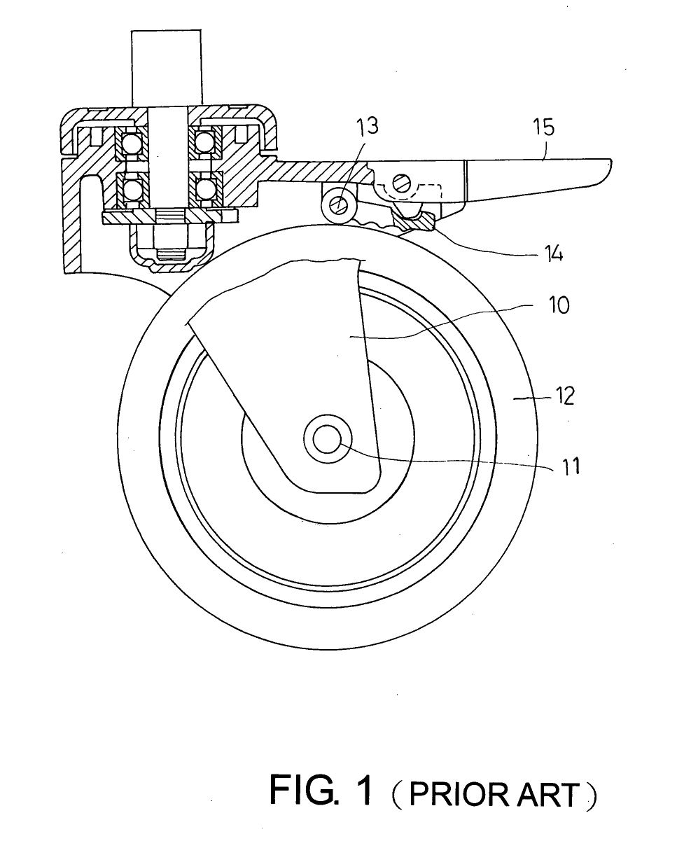

FIG. 2 is a cross-sectional view of the known conventional castor being operated in another way;

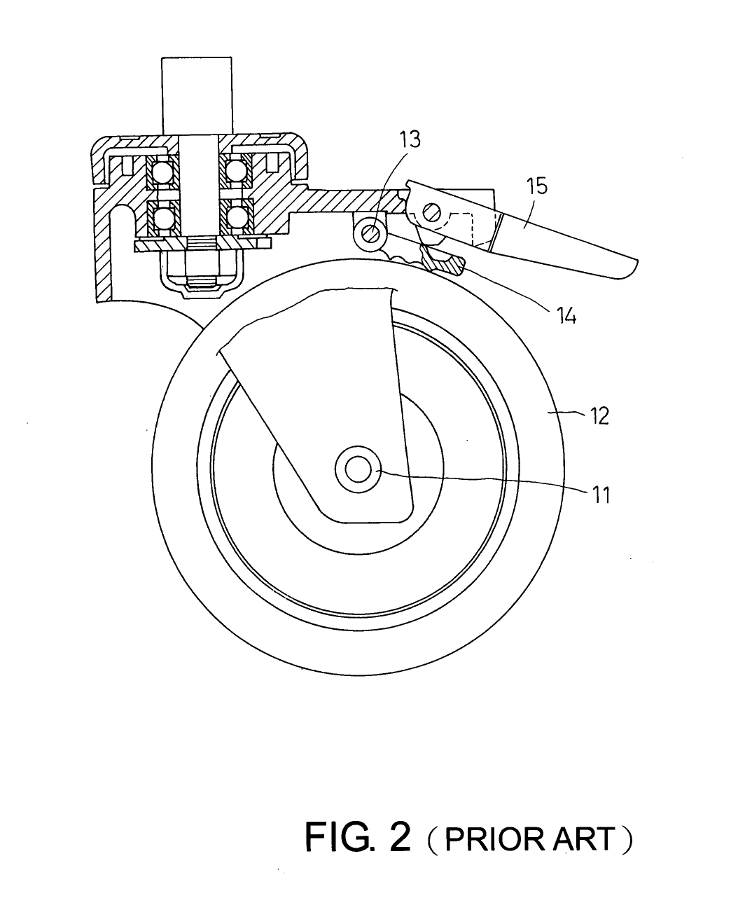

FIG. 3 is an exploded perspective view of a castor in the present invention;

FIG. 4 is a perspective view of the castor in the present invention;

FIG. 5 is a composite perspective drawing of the castor in the present invention;

FIG. 6 is the section view of the braking and positioning effect of the castor in the present invention;

FIG. 7 is an exploded perspective view of another real embodiment of the castor in the present invention;

FIG. 8 is a composite perspective view of another real embodiment of the castor in the present invention;

FIG. 9 is an exploded perspective view of another real embodiment of the castor in the present invention; and

FIG. 10 is a composite perspective view of another real embodiment of the castor in the present invention.

### DETAILED DESCRIPTION OF THE PREFERRED EMBODIMENT

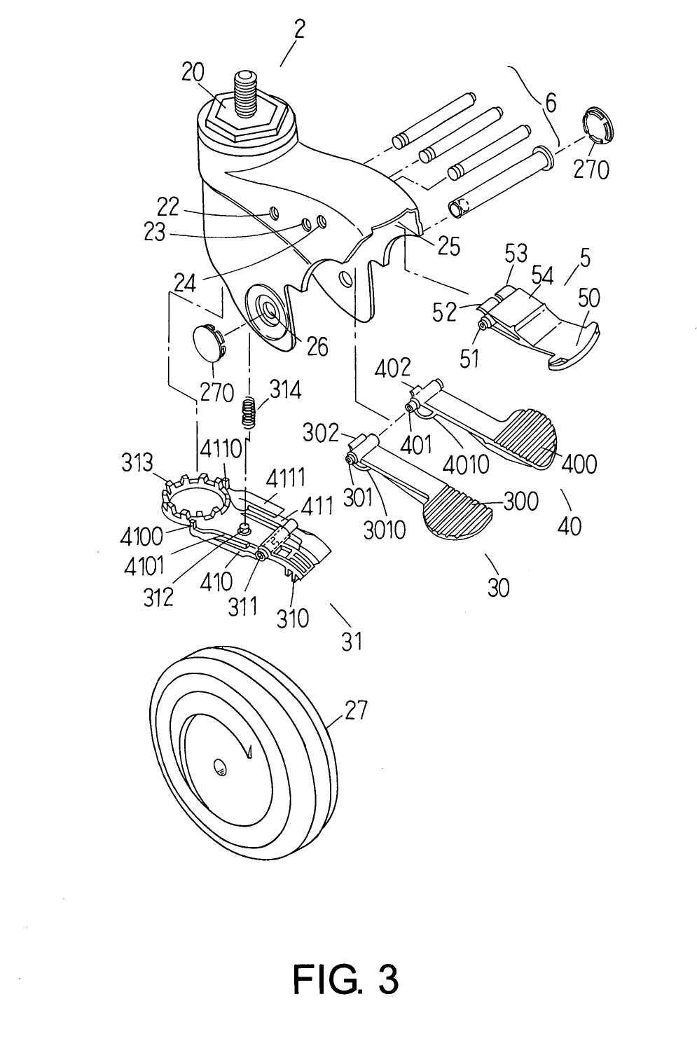

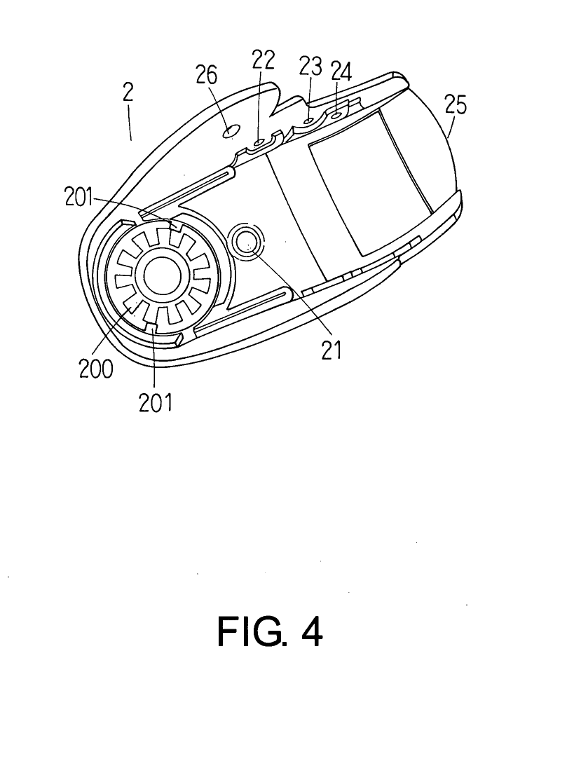

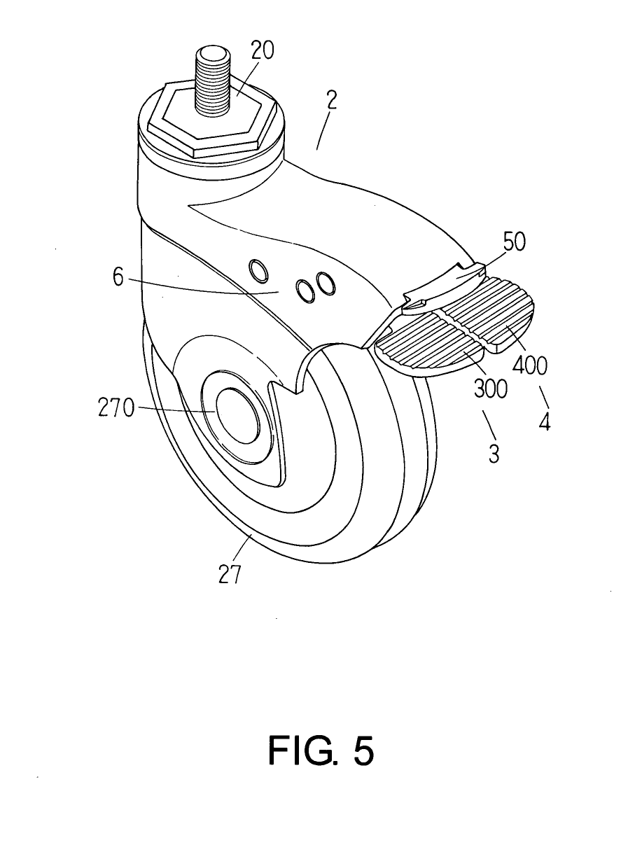

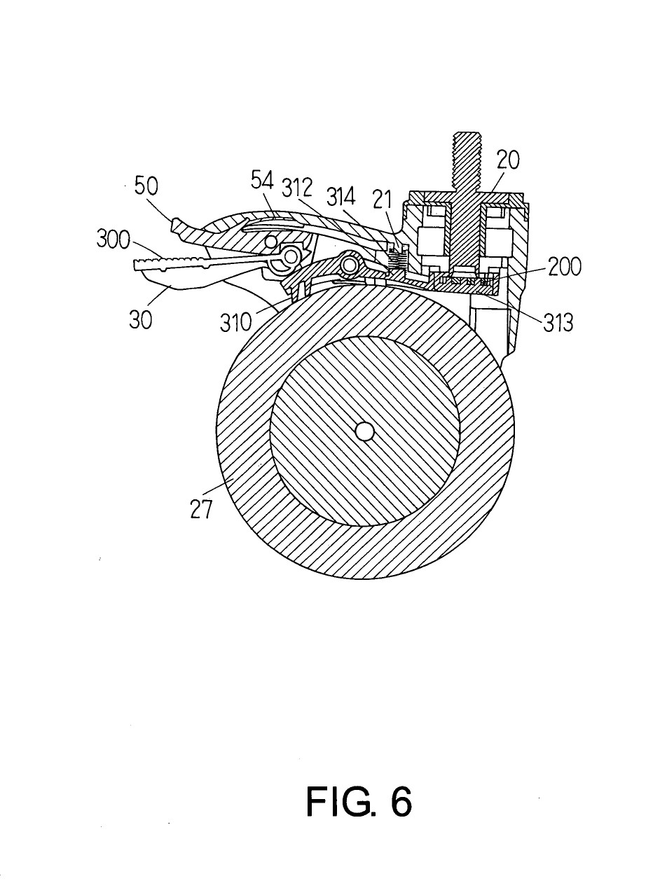

A preferred embodiment of a castor in the present invention, as shown in FIGS. 3 to 6, includes a castor main body 2, a brake system 3, a directional system 4, a release mechanism 5 and a number of positioning elements 6.

A castor main body 2 there is a connecting base 20 which is the direction change center. On the bottom of the revolving shaft hole is a direction change engaging fluted disc 200 and positioning trough 201. The inside of the castor main body 2 has a convex positioning body 21 on the concave face and a number of positioning holes 22, 23 and 24. The front of the castor main body has a concave surface 25 and there are pin joint hole 26, wheel 27 and cover 270 on the bottom of the concave surface of the castor main body.

A brake system 3 is on the concave surface of the bottom of castor main body 2. Brake system 3 includes pressure platelet 30 and brake direction change body. The pressure platelet 30 has a pressure part at the front and, at the other end, has a pin joint hole 301 and an engaging convex body 302. On the bottom of the pin joint hole 301 there is a cambered surface 3010. Brake direction change body 31 has a brake pressing part 310, pin joint hole 311, convex body 312, direction change engaging fluted disc 313 and flexible element 314.

A directional system 4 is in the concave surface of the bottom of the castor main body. The directional system is made up of a pressure platelet 40 and two directional platelets 41. The pressure platelet 40 has a pressure part 400, pin joint hole 401 and engaging convex body 402. At the bottom of the pin joint hole is a cambered surface 4010. Directional platelet 41 comprises of two engaging elastic platelets 410, 411. Elastic platelets 410 and 411 have an engaging trough at the front, allowing them to be joined and work at the same time. At the end there are positioning convex bodies 4100, 4110 and elastic platelets 4101 and 4111. Release mechanism 5 is joined to the inside concave face of the castor main body 2 and protrudes beyond the convex face.

A release mechanism 5 has a pressure part 50, pin joint hole 51, engaging part 52 and 53 and flexible platelet 54 and a number of positioning elements 6.

When assembling as shown in FIG. 3, first place the castor main body 2 upside down, then join the release mechanism 5 to the positioning hole 24 on the castor main body 2's concave surface, then place pressure platelet 30 of brake system 3 and pressure part 40 of the directional system 4 flat, on the release mechanism 5 and use positioning element 6 to join it to positioning hole 23 on the castor main body 2. Then, the pin joint hole 311 of brake directional change body 31 engages with the engaging trough of the engaging elastic platelets 410 and 411 of direction change system 4, fixing flexible element 314 on the positioning convex body 21. Then attach the joined-together brake direction change body 31 and directional platelet 41 to the concave surface of the castor main body, positioning engaging fluted disc 313 of the brake direction change body 31 above the direction change engaging fluted disc 200 of castor main body 2 and place convex body 312 on the bottom of the brake direction change body on the elastic element 314 above the convex body, so that the direction change body 31 and the castor main body 2 have an elastic effect between them. Pass positioning element 6 through positioning hole 22 and attach to the pin joint hole 311 of the brake direction change body 31. Finally, attach the wheel 27 to the bottom of castor main body 2 by putting positioning element 6 through pin joint hole 26 and, after passing through connecting base 20, use positioning element 6 to attach cover 270 and the assembly process is complete.

When wanting to stop the wheel and change direction, it is necessary to press down the pressure part 300 of the brake system 3 which will make the cambered surface 3010 of pressure platelet 30 move the brake system direction change body 31. At this time, the brake pressing part 310 of the brake direction change body 31 will be pushed by the curved face 3010 and force the pressing face against the surface of the wheel 27. The other end of the direction change body 31 will, at the same time, be pushed up by the pin join hole 301's cambered surface 3010, causing the direction change engaging fluted disc 313 and direction change engaging fluted disc 200 to lock together. This allows the brake to be applied on wheel 27 and direction to be set at the same time.

When you want to release the brake on wheel 27 and change direction, the pressure part 50 of the release mechanism 5 has to be pressed down. This will cause the engaging convex body 302 on the front of the pressure platelet 30 of brake system 3 to separate from the engaging part 52 of release mechanism 5 and, under the elastic effect of the brake direction change body 31, it will move upwards. At this time brake direction change body 31 will be subject to the elastic effect of elastic element 314 and will separate from the direction change engaging fluted disc 200. Release mechanism 5 will also be affected by elastic platelet 54 and return to its original position, while pressure platelet 30 will return to a horizontal position. This allows wheel 27 braking and direction change to be easily carried out.

When you want to set direction, its necessary to press down the pressure part 400 of directional system 4, upon which time the cambered surface 4010 of pressure platelet will exert downward pressure on positioning platelet 41, and positioning platelet 41 will be affected by cambered surface 4010 of the pin joint hole and the convex bodies 4100 and 4110 at the front will rise up and insert into the positioning troughs 201 of the connecting base 20 at the bottom of castor main body 2.At this time the direction of wheel 27 is fixed and can only go straight.

When releasing the set direction, it is necessary to press down the pressure part 50 of the release mechanism. At this time, the engaging convex body 402 of the front of the pressure platelet on directional system 4 will separate from the engaging part 53 of release mechanism 5. Positioning platelet 41 will be affected by elastic platelet 4101 and 4111 and spring out of the positioning trough, at the same time, pressure platelet 40 will spring back to its original horizontal position. Thus, the direction setting of wheel 27 is released.

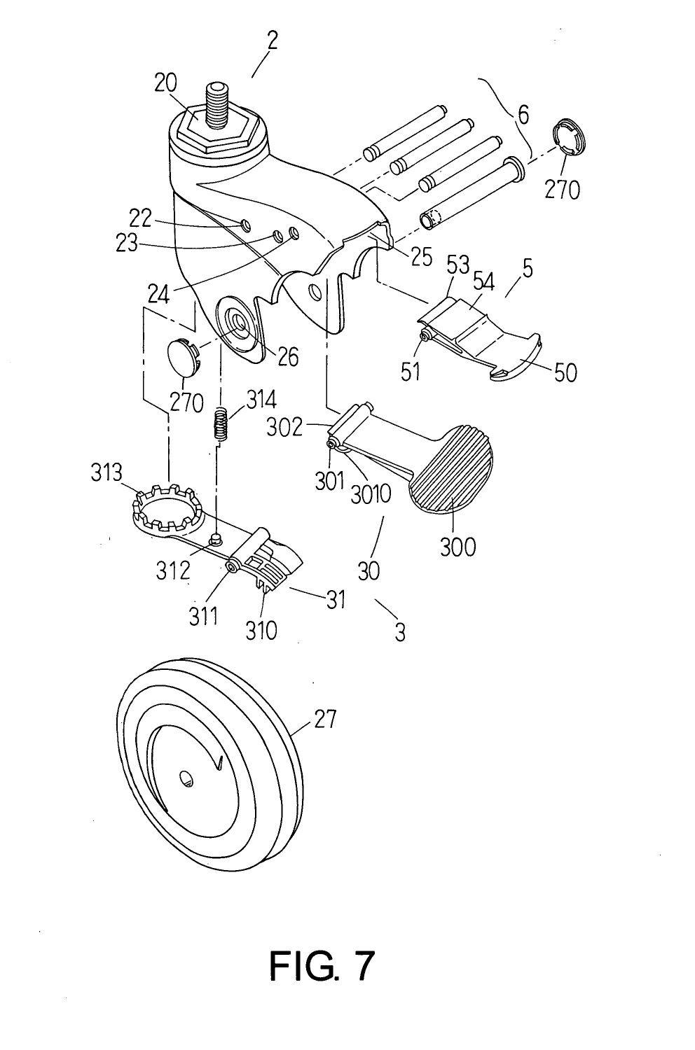

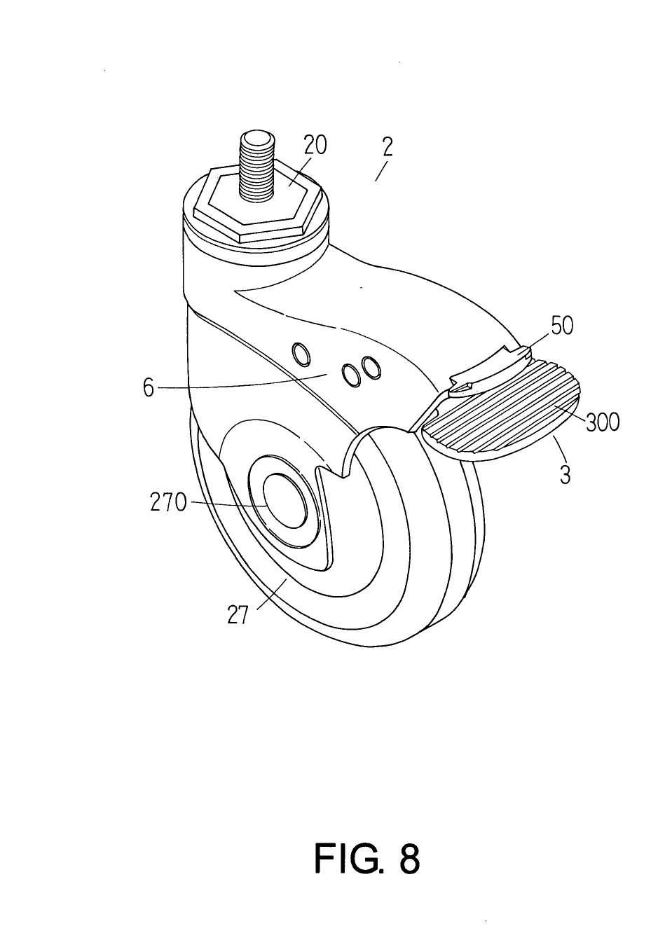

As shown in FIGS. 7-8, another real embodiment of this invention is comprised: castor main body 2, brake system 3, release mechanism 5 and several positioning elements 6.

The castor main boy 2 there is the direction change center's revolving connecting base 20, under which there is direction change engaging fluted disc 200, and inside castor main body 2 on the concave surface there is a positioning convex body 21 and positioning holes 22,23 and 24, and the front of the castor main body there is a convex surface 25 and under the castor main body convex surface there is a pin joint hole 26, wheel 27 and cover 270.

The brake system 3 is inside the concave surface of the bottom of castor main body 2 and includes pressure platelet 30 and brake direction change body 31 and other parts. On the front of the pressure platelet 30 is the pressure part 300. The other end has a pin joint hole 301 and engaging convex body 302. Under the pin joint hole is a cambered surface 3010. The brake direction change body 31 comprises of a brake pressing part 310, pin joint hole 311, convex body 312, direction change engaging fluted disc 313 and elastic element 314.

The release mechanism 5 is joined to the concave surface 25 of the castor main body, and the release mechanism has a pressure part 50, pin join hole 51, engaging part 53, elastic platelet 54 and a number of positioning elements 6.

When braking and direction change is required, all that is needed is to press down the pressure part 300 of brake system 3 and the cambered surface 3010 of pressure platelet will move the brake direction change body At this time the brake pressing face 310 of the direction change body 31 will be pressed down against the wheel 27 surface. The other end of brake direction change body 31 will be affected by the cambered surface 3010 of the pin joint hole 301, causing the direction change engaging fluted disc 313 and the direction change fluted disc 200 to fit together. This way, wheel 27 braking and direction change and setting can be easily achieved.

When releasing wheel 2 brakes and direction change, all that is needed is to press down the pressure part 50 of release mechanism 5, at this time the engaging convex body 302 at the front a the front of pressure platelet 30 of the brake system will separate from the engaging part 53 of the release mechanism 5 and will subject to the elastic effect of brake direction change body 31, spring up, at this time, brake direction change body 31 also is subject to the elastic effect of elastic element 314 and separates from the direction change engaging fluted disc 200 and release mechanism 5 is subject to elastic platelet 54's effect and will spring back to its original position. Pressure platelet 30 will also spring back to a horizontal position. This way wheel 27 brakes and direction change can be easily released.

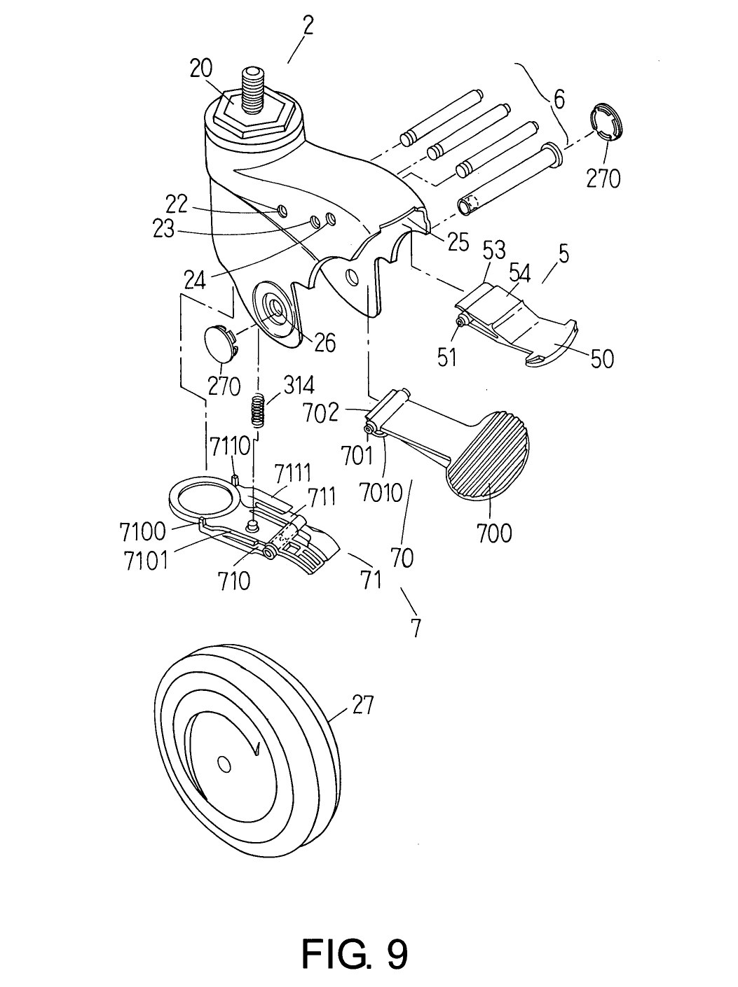

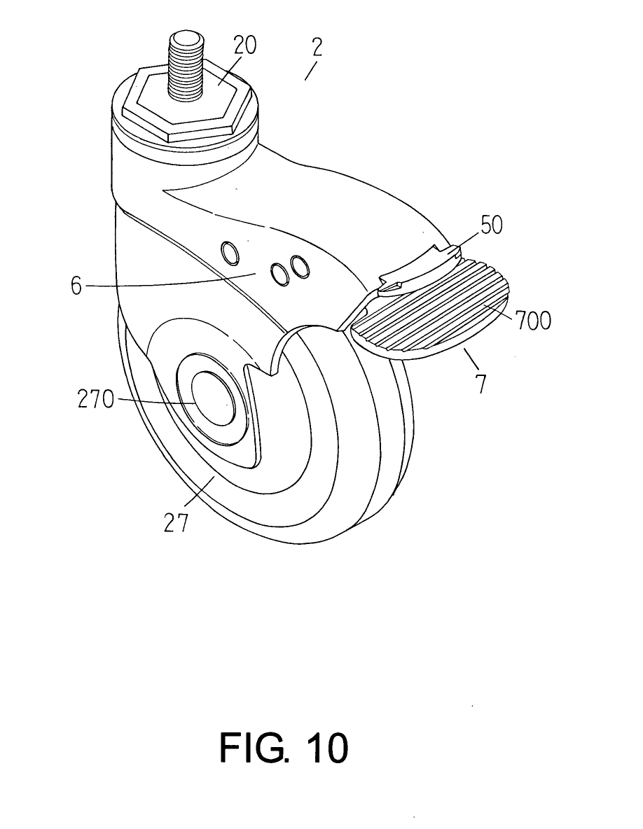

As shown in FIGS. 9-10, another real embodiment of this invention is comprised: a castor main body 2 directional system 7, release mechanism 5 and a number of positioning elements 6.

A castor main body 2 there is a revolving shaft hole 20 which is the direction change center and under the revolving connecting base 20 is a direction change engaging fluted disc 200 and positioning trough 201. The concave face on the inside of the castor main body has a positioning convex body and positioning holes 22, 23 and 24. At the front of castor main body 2 there is a concave surface 25. Under the concave surface of the castor main body 2 there is a pin joint hole, wheel 27 and cover 270.

The directional system 7 is in the concave face of the bottom of the castor main body and is made up of a pressing platelet 70 and positioning platelet 71. Pressure platelet 70 has a pressure part 700, a pin joint hole 701 and engaging convex body 702. Under pin joint hole 701 is a curved faced body 7010, and the positioning platelet 71 is made by inserting the engaging elastic platelets 710 and 711 into each other. At the front of engaging elastic platelets 710 and 711 there is a trough allowing them to be joined together and move at the same time. At the end are positioning convex bodies 7100 and 7110 and elastic platelets 7101 and 7111. Release mechanism 5 is joined to the concave surface inside castor main body 2 and protrudes beyond the concave surface 25. On release mechanism 5 there is a pressure part 50, pin joint hole 51, engaging part 53, elastic platelet 54 and a number of positioning elements.

When direction setting is required, all that is needed is that pressure part 700 of the directional system 7 is pressed down, at which time the cambered surface 7010 under the pressure platelet 70 will exert downward force on positioning platelet 71, the positioning platelet 71 will be pushed by the cambered surface 7010 of pin joint hole 701 and the front positioning convex bodies 7100 and 7110 will rise up and fit into the positioning trough 201 of connecting base 20 under the castor main body 2. At this time, wheel 27's connecting base 20 is engaged in position and can only move straight forward.

When releasing the direction setting, all that is needed is to press down pressure part 50 of the release mechanism 5. At this time, the engaging convex body 702 on the front on the pressure platelet 70 of the directional system 7 will separate from the engaging part 53 of the release mechanism, and the Positioning platelet 71 will be subject to the elastic force of elastic platelet 7101, 7111 and will spring out of the positioning trough 201. At the same time pressure platelet 70 will spring back to its original horizontal position. At this time the direction setting of wheel 27 has been released.

The above explanation shows that this invention has the following advantages:

1. This invention's brake system 3 and directional system are combined, making use easier.

2. By pressing down the brakes can be easily completed, making use extremely simple and easy.

3. When the brakes are applied the direction change can also be fixed, allowing two objectives to be achieves.

4. The interaction of pressure part 50 and pin joint hole 51 allow castor direction fixing or release to be achieved, making use very simple.

5. The operating sound of brake system 3 and directional system 4 is small. This makes the invention suited for use on patient beds and medical establishment and other places where quiet is needed where the invention has advantages over existing products

While the preferred embodiment of the invention has been described above, it will be recognized and understood that various modifications may be made therein and the appended claims are intended to cover all such modifications that may fall within the spirit and scope of the invention.

What is claimed is:

1. A castor comprising:
a castor main body: on the castor main body there is a revolving, shaft hole on which there are a directional engaging fluted disc and directional trough, said the concave face on the inside of the castor main body, there is a positioning convex body, a number of positioning holes and pin joint holes;
a brake system is on the concave face in the bottom of the castor main body, said brake system includes pressure platelet and brake direction change body, the former moves the latter when they touch, said brake direction change body there is an engaging part and a brake engaging fluted disc;
a directional system is on the concave surface on the bottom of the of said castor main body, said made up of a pressure platelet and directional platelet, the former activates the latter when they touch, there is a positioning convex body on the directional platelet;
a release mechanism is joined to the concave surface of the castor main body, protruding from the concave face, the release mechanism has a pressure part, pin joint hole and engaging part;
a number of positional elements joining and fixing the brake system, the directional system and the release mechanism in the castor main body; and, said the aforementioned part combination allows castor braking and direction turning to be carried out simultaneously or direction to be fixed alone, providing a castor mechanism with more functions.

2. A castor comprising:
a castor main body, on which there revolving shaft hole, on the bottom of which there is a directional engaging fluted disc and positioning trough, on the inside concave surface of the castor body there is a positioning convex body, a number of positioning holes and pin joint holes;
a brake system: is on the concave surface of the bottom of the castor main body, the brake system includes pressure platelet and brake direction change body, said the pressure platelet touches the brake direction change body, the latter moves, said direction change body has a pressing part and a brake engaging fluted disc;
a release mechanism is joined to the concave surface of the castor main body, protruding from the concave face, the release mechanism has a pressure part, pin joint hole and engaging part;
a number of positional elements joining and fixing the brake system, the directional system and the release mechanism in the castor main body; and,
said the aforementioned combination will provide a more practical and convenient castor mechanism.

3. The pressure platelet of the brake system for a castor as claimed in claim 1, wherein said the pressure platelet includes pressure part, pin joint hole and engaging trough and thus it can be positioned on the positioning hole of the castor main body and thus activate the brake directional body.

4. The brake system directional body for a castor as claimed in claim 1, wherein said the brake system directional body includes pressing part, pin joint hole, convex body, directional engaging fluted disc and this can achieve the objectives of braking and setting direction.

5. A castor comprising:
a castor main body: the castor main body has a revolving shaft hole on it and on the bottom of this is a directional engaging flute disc and positioning trough, the concave surface inside the castor main body there is a positioning convex body and a number of positioning holes and pin joint holes;
a directional system is on the concave surface on the bottom of the castor main body, said made up of a pressure platelet and directional platelet, the former activates the latter when they touch, there is a positioning convex body on the directional platelet;
a number of positional elements joining and fixing the brake system, the directional system and the release mechanism in the castor main body.
